(19) United States
(12) Patent Application Publication
(10) Pub. No.: US 2024/0330746 A1
(43) Pub. Date: Oct. 3, 2024

(54) Outlier Detection Based On Synthetic Trend Generation For Machine Learning

(71) Applicant: PAYPAL, INC., San Jose, CA (US)

(72) Inventor: Adam Inzelberg, Tel Aviv (IL)

(21) Appl. No.: 18/192,721

(22) Filed: Mar. 30, 2023

(51) Int. Cl. G06N 20/00

(52) U.S. Cl. CPC G06N 20/00

(57) ABSTRACT

Historical outlier data corresponding to a plurality of user accounts is accessed. The historical outlier data are extracted from historical outlier events, which may correspond to fraud trends or malicious activities. Based on the historical outlier data and using a minority oversampling technique, synthetic outlier data associated with the user accounts is generated. The synthetic outlier data mimics data associated with potential future outlier events that may be similar, but not identical, to any of the historical outlier events. The historical outlier data, at least a subset of the synthetic outlier data, and historical non-outlier data associated with the user accounts are combined into a unified dataset, which may be used to train a machine learning model. Based on the trained machine learning model, new data associated with the user accounts is classified as either outlier data or non-outlier data.

### BACKGROUND

### Field of the Invention

The present application generally relates to machine learning. More particularly, the present application involves using synthetically generated trends to train machine learning models, and using the trained machine learning models to detect outliers according to various embodiments.

### Related Art

Rapid advances have been made in the past several decades in the fields of computer technology and telecommunications. These advances have led to more and more operations being conducted electronically. Although historical data can be extracted from these operations, the amount of extracted historical data may not be sufficient to make machine-automated predictions, such as whether a future online operation is an outlier that may indicate fraud. What is needed is a system and method to generate synthetic data to simulate outlier trends, and using the synthetically-generated data to train a machine learning model, so that the trained machine learning model can be used to make more accurate machine-automated predictions for future online operations.

### BRIEF DESCRIPTION OF THE FIGURES

FIG. 1 is a block diagram of an example environment in which outlier data can be generated according to various aspects of the present disclosure.

FIG. 2 is a block diagram of another example environment in which outlier data can be generated according to various aspects of the present disclosure.

FIG. 3 is a block diagram of a process flow for generating synthetic outlier data and using the synthetic outlier data to perform machine learning according to various aspects of the present disclosure.

FIG. 4 is a flowchart illustrating a method of machine learning according to various aspects of the present disclosure.

FIG. 5 is an example computer system according to various aspects of the present disclosure.

FIG. 6 illustrates an example system involving neural networks according to various aspects of the present disclosure.

FIG. 7 is a simplified example of a cloud-based computing architecture according to various aspects of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

The present disclosure pertains to using machine learning to make predictions regarding outliers in a given environment. In more detail, machine learning is a useful tool to detect outliers in a variety of areas, including but not limited to, cyber security and/or online fraud prevention. In some machine learning schemes, historical data associated with events (e.g., online activities or electronic transactions) that have already occurred may be extracted and used to train a machine learning model. The trained machine learning model may then be used to make predictions. For example, the historical data may include data associated with fraudulent transactions or cyber-attacks. In that case, the trained machine learning model May be used to predict whether a particular electronic transaction may be a fraudulent transaction, or whether a particular online activity may be a cyber-attack.

However, these types of machine learning schemes may not react sufficiently quickly to rapidly-developing trends. For example, malicious actors may constantly develop new ways of perpetrating fraud. These new ways of perpetrating fraud may have different characteristics from previous fraud trends. As such, the amount and/or type of training data gathered before the development of the new fraud trends may not be sufficient to accurately train the machine learning models to make accurate predictions about events associated with the new fraud trends. Stated differently, the machine learning models trained using stale data may not be able to make the most accurate predictions. For example, the machine learning models may not be able to correctly detect these outliers corresponding to the new fraud trends.

To address these issues discussed above, the present disclosure generates data synthetically to mimic potential outlier trends that could occur in the future. The synthetically-generated data, along with historical outlier data corresponding to actual outlier events that have occurred, may be combined into a unified dataset to train machine learning models. In some embodiments, the synthetically-generated data may be generated by varying the values of one or more parameters of an instance of the historical outlier data, while maintaining the values of at least a subset of the remaining parameters of the instance of the historical outlier data. For example, an instance of a historical outlier event may correspond to a fraudulent online transaction that was based on a request originated in Malaysia, with a VPN connection from Europe, and using an Android emulator. In this simplified example, the request being originated in Malaysia is a first parameter of the historical outlier event, the VPN connection from Europe is a second parameter of the historical outlier event, and the Android emulator is a third parameter of the historical outlier event. Based on this instance of the historical outlier event, a hypothetical future outlier event may be synthetically generated by changing the location of the request generation from Malaysia to another country in Southeast Asia, for example, Indonesia, while maintaining the VPN connection from Europe and the Android emulator. Alternatively, another hypothetical future outlier event may be synthetically generated by changing the VPN connection from Europe to North America, while maintaining the location of the request generation to Malaysia and the Android emulator.

Regardless of how the parameters may be varied to generate the synthetic outlier events, it can be seen that a large amount of synthetic data can be quickly created to simulate potential future outlier events, for example, events that correspond to fraudulent online transactions and/or malicious online activities. The synthetically-generated data may then be combined with the historical data (including data corresponding to historical outlier events and historical non-outlier events) to generate a unified dataset. The unified dataset may then be used to train machine learning models, such as a tree-based machine learning model, a neural network based machine learning model, or a deep learning machine model. With a sufficient amount of data, the machine learning models may now be trained to accurately identify future events that would correspond to outlier events, even though these types of outlier events have not actually occurred in real life yet. In other words, the synthetically-generated data may sufficiently and accurately simulate outlier events that could take place in the future (but that haven't happened yet), such that the machine learning models trained based on the synthetically-generated data may be able to accurately detect future outlier events whose parameters are similar to the parameters of the synthetically-generated data. For example, the machine learning model may generate a score for each future event. Events whose scores exceed a specified threshold may be classified as outlier events, and events whose scores are below the specified threshold may be classified as non-outlier events, or vice versa.

One feature of the present disclosure is that the machine learning model may also be used to indicate the importance of each parameter of the events in the machine learning model making the prediction in some embodiments. For example, the contribution from each individual parameter may be calculated separately. By doing so, a rationale may be provided to an entity whose request has been rejected by the machine learning model, as the machine learning model has classified the request made by the entity to be an outlier request (e.g., a fraudulent transaction or a malicious activity). This provides an opportunity to the entity (who made an otherwise legitimate request) to reconfigure certain parameters associated with the request (e.g., by changing the VPN connection), such that the machine learning model is more likely to grant the request with the reconfigured parameters.

Over time, new/organic outlier trends (e.g., new methods developed by malicious actors to engage in unauthorized activities) may occur. The data associated with the events behind these new/organic outlier trends may be used to retrain the machine learning models, which may be referred to as a Rapid Model Refresh (RMR). After the machine learning models have been retrained, a comparison is made as to the predictions made by the originally-trained machine learning models and the predictions made by the retrained machine learning models. Whichever machine learning model is capable of making more accurate predictions will be adopted as the machine learning model going forward to make future predictions.

The present disclosure improves the functionality of a computer, for example, by improving the machine learning capabilities and its prediction accuracies. This is achieved at least in part by generating synthetic data in a manner to mimic potential outlier events that have not occurred yet. As such, the machine learning models trained using the present disclosure may accurately catch outliers that have no exact corresponding events in historical data. In other words, the computers on which the machine learning models of the present disclosure are built may detect outliers with greater speed and better accuracy.

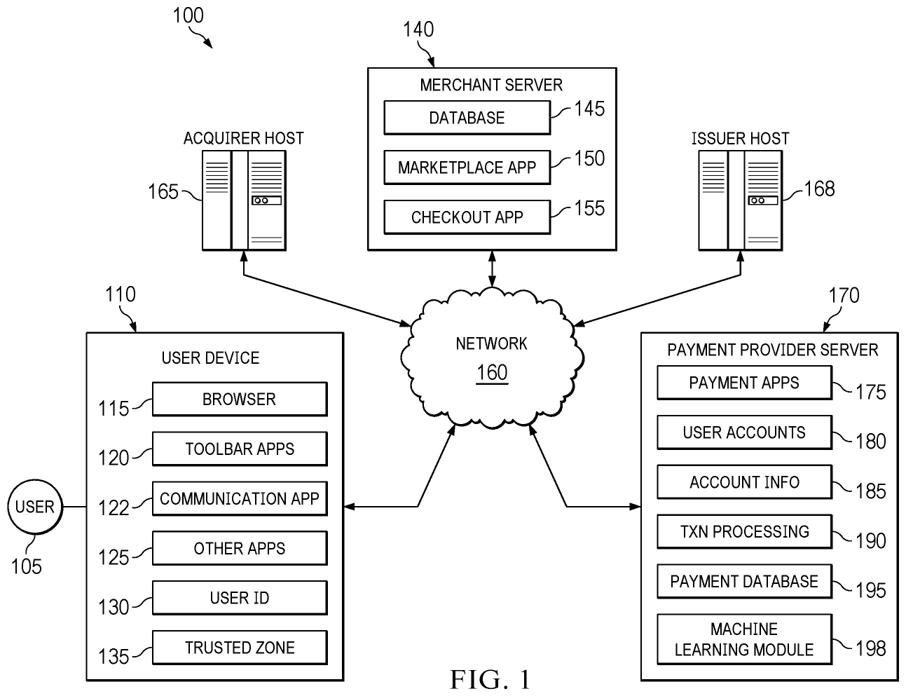

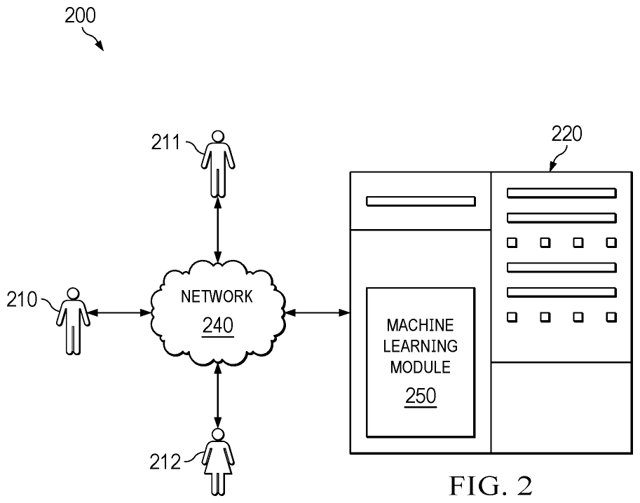

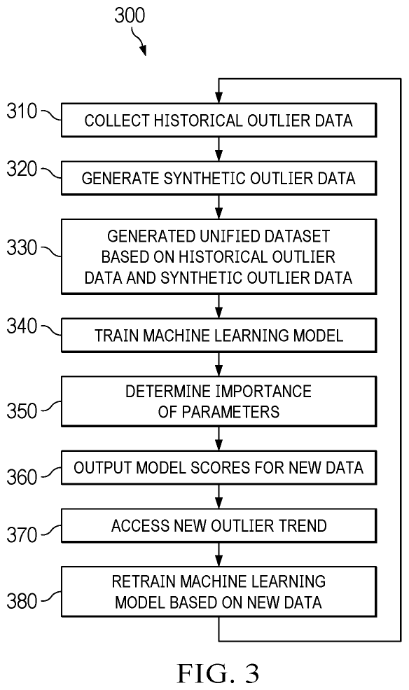

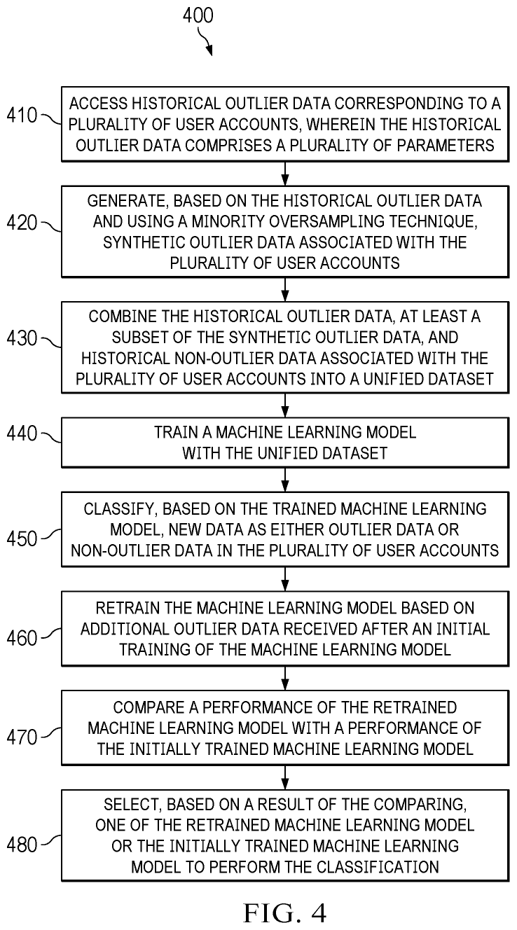

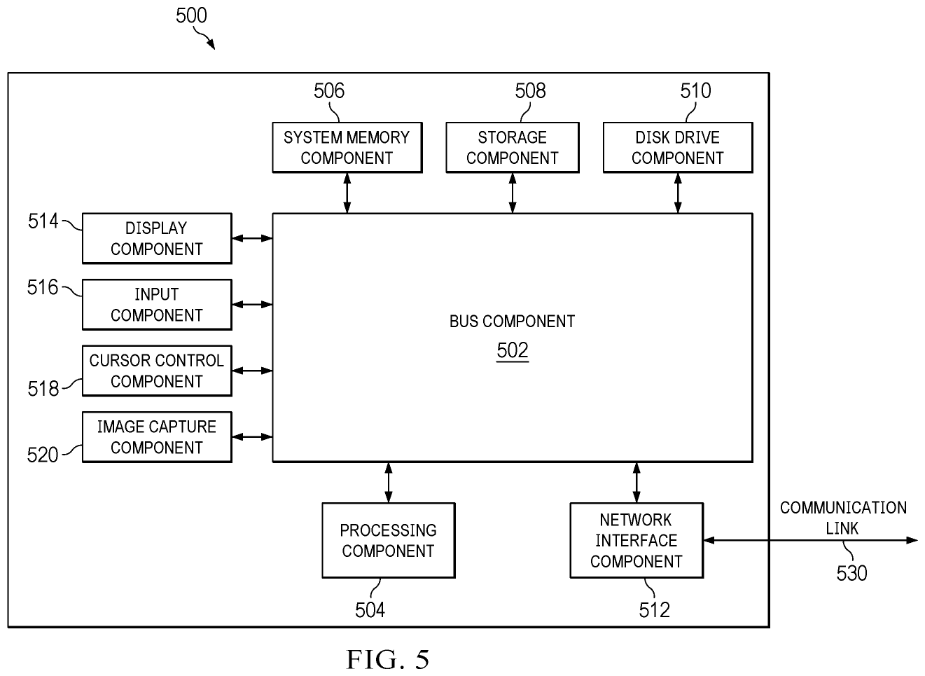

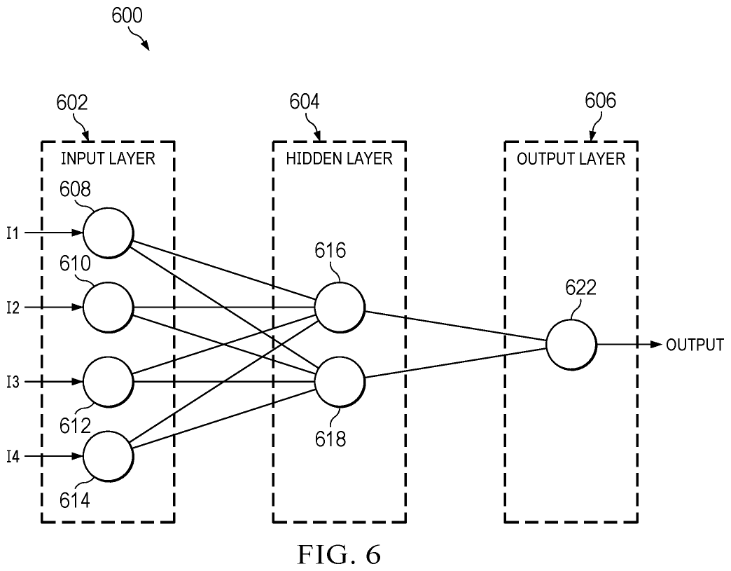

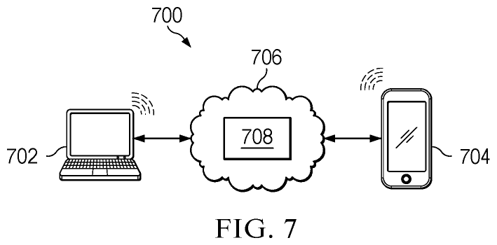

The various aspects of the present disclosure are discussed in more detail with reference to FIGS. 1-7. In more detail, FIGS. 1-2 each illustrate an example context in which outlier data may be generated according to embodiments of the present disclosure. FIG. 3 illustrates a process flow of training a machine learning model using synthetically-generated outlier data according to embodiments of the present disclosure. FIG. 4 illustrates a flowchart of performing a machine learning process according to embodiments of the present disclosure. FIG. 5 illustrates an example computer system for performing in various methods of the present disclosure. FIG. 6 illustrates an example machine learning architecture according to embodiments of the present disclosure. FIG. 7 illustrates an example cloud computing architecture according to embodiments of the present disclosure.

Referring now to FIG. 1, a block diagram of a networked system 100 is illustrated. The networked system 100 corresponds to an environment that is suitable for conducting electronic online transactions, where outlier events (e.g., fraudulent transactions) may occur. Networked system 100 may comprise or implement a plurality of servers and/or software components that operate to perform various payment transactions or processes. Exemplary servers may include, for example, stand-alone and enterprise-class servers operating a server OS such as a MICROSOFT™ OS, a UNIX™ OS, a LINUX™ OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

The system 100 may include a user device 110, a merchant server 140, a payment provider server 170, an acquirer host 165, and an issuer host 168 that are in communication with one another over a network 160. Payment provider server 170 may be maintained by a payment service provider, such as PayPal™, Inc. of San Jose, CA. A user 105, such as a consumer, may utilize user device 110 to perform an electronic transaction using payment provider server 170. For example, user 105 may utilize user device 110 to visit a merchant's web site provided by merchant server 140 or the merchant's brick-and-mortar store to browse for products offered by the merchant. Further, user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant server is shown, a plurality of merchant servers may be utilized if the user is purchasing products from multiple merchants.

User device 110, merchant server 140, payment provider server 170, acquirer host 165, and issuer host 168 may each include one or more electronic processors, electronic memories, and other appropriate electronic components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, a smart phone with additional hardware such as NFC chips, BLE hardware etc., wearable devices with similar hardware configurations such as a gaming device, a Virtual Reality Headset, or that talk to a smart phone with unique hardware configurations and running appropriate software, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a digital wallet through the payment provider as discussed herein.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100. User device 110 may also include other applications 125, for example the mobile applications that are downloadable from the Appstore™ of APPLE™ or GooglePlay™ of GOOGLE™.

In conjunction with user identifiers 130, user device 110 may also include a secure or trusted zone 135 owned or provisioned by the payment service provider with agreement from device manufacturer. The secure zone 135 may also be part of a telecommunications provider SIM that is used to store appropriate software by the payment service provider capable of generating secure industry standard payment credentials or other data that may warrant a more secure or separate storage, including various data as described herein.

Still referring to FIG. 1, merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be payment or gift to an individual. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145. In some embodiments, the merchant server 140 may also host a website for an online marketplace, where sellers and buyers may engage in purchasing transactions with each other.

Merchant server 140 also may include a checkout application 155 which may be configured to facilitate the purchase by user 105 of goods or services online or at a physical POS or store front. Checkout application 155 may be configured to accept payment information from or on behalf of user 105 through payment provider server 170 over network 160. For example, checkout application 155 may receive and process a payment confirmation from payment provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Payment provider server 170 may be maintained, for example, by an online payment service provider which may provide payment between user 105 and the operator of merchant server 140. In this regard, payment provider server 170 may include one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, usernames, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, as described herein. As such, transaction processing application 190 may store details of an order from individual users, including funding source used, credit options available, etc. Payment application 175 may be further configured to determine the existence of and to manage accounts for user 105, as well as create new accounts if necessary.

According to various aspects of the present disclosure, a machine learning module 198 may also be implemented on, or accessible by, the payment provider server 170. The machine learning module 198 may include one or more software applications or software programs that can be automatically executed (e.g., without needing explicit instructions from a human user) to perform certain tasks. For example, the machine learning module 198 may electronically access one or more electronic databases (e.g., the database 195 of the payment provider server 170 or the database 145 of the merchant server 140) to access or retrieve electronic data pertaining to user accounts of users, such as the user 105, or transactions conducted by the user 105 or other users. In some embodiments, the retrieved electronic data may contain historical outlier data pertaining to outlier transactions (e.g., fraudulent transactions) conducted by the user 105 or by other users.

The machine learning module 198 may use the retrieved historical outlier data to generate synthetic outlier data that simulates hypothetical outlier transactions. In some embodiments, the machine learning module 198 may generate the synthetic outlier data using a minority oversampling technique. In some embodiments, the synthetic outlier data may be generated at least in part by varying a value of one of the parameters of an instance of the outlier data (e.g., corresponding to a particular outlier transaction), while maintaining the values of the remaining parameters of the instance of the outlier data. In the electronic commerce environment of FIG. 1, the example (and non-limiting) parameters of the outlier data may include amount of transaction, type of transaction, items/goods involved in the transaction, geographical location of transaction, VPN connection information, device type information, device identification information, etc., and the value of anyone of the above parameters may be varied to generate the synthetic outlier data.

As a simplified example, one historical outlier transaction may be a request to conduct an electronic transaction, where the request originated from Malaysia, and a VPN connection to Europe is used, and an Android emulator is also used. A hypothetical outlier transaction may be generated based on this actual historical outlier transaction, for example, by changing the location of to request a registration from Malaysia to Indonesia, while maintaining the VPN connection to Europe and the Android emulator. In some embodiments, the hypothetical transaction is different from any actual historical transaction corresponding to the historical outlier data, as its parameter values are not identical to those of the actual historical transactions.

The synthetically-generated outlier data may be combined with the historical outlier data, as well as historical non-outlier data associated with the user accounts, to produce a unified dataset. Such a unified dataset may be used by the machine learning module 198 to train a machine learning model. Based on the trained machine learning model, the machine learning module 198 may classify new data as either outlier data or non-outlier data. The details regarding the generation of the synthetic outlier data, as well as using the synthetic outlier data to train the machine learning module 198, will be discussed in more detail below with reference to FIG. 3.

Based on the above, the machine learning module 198 can automate decision-making processes, such as the classification of new events as outlier events or non-outlier events. Using state-of-the-art machine learning techniques, the machine learning module 198 may quickly, accurately, and automatically determine whether a new event is an outlier event. For example, fraudulent transactions may be accurately and quickly classified as outlier transactions, and therefore should not be processed. In turn, this helps conserve system resources. In other words, the processing of fraudulent transactions not only results in loss of financial resources for involved parties, it they also needlessly consumed computer resources that could otherwise be used to process legitimate electronic transactions. Since the machine learning module 198 can detect these fraudulent transactions automatically, it not only frees up the computer processing resources, but also reduces unnecessary network traffic (that would otherwise be occupied to process the fraudulent transactions), thereby freeing up network communication bandwidth. As such, the machine learning module 198 transforms a generic computer into a special machine capable of performing a specific predefined task: identifying which events (e.g., electronic transactions) are outlier events (e.g., fraudulent transactions).

Accordingly, the present disclosure offers an improvement in computer technology.

It is noted that although the machine learning module 198 is illustrated as being separate from the transaction processing application 190 in the embodiment shown in FIG. 1, the transaction processing application 190 may implement some, or all, of the functionalities of the machine learning module 198 in other embodiments. In other words, the machine learning module 198 may be integrated within the transaction processing application 190 in some embodiments. In addition, it is understood that the machine learning module 198 (or another similar program) may be implemented on the merchant server 140, on a server of any other entity operating a social interaction platform, or even on a portable electronic device similar to the user device 110 (but may belong to an entity operating the payment provider server 170) as well. It is also understood that the machine learning module 198 may include one or more sub-modules that are configured to perform specific tasks. For example, the machine learning module 198 may include a first sub-module configured to train the machine learning model, as well as a second sub-module configured to make predictions based on the trained model.

Still referring to FIG. 1, a payment network may be operated by payment card service providers or card associations, such as DISCOVER™, VISA™, MASTERCARD™ AMERICAN EXPRESS™, RUPAY™, CHINA UNION PAY™, etc. The payment card service providers may provide services, standards, rules, and/or policies for issuing various payment cards. The payment network interfaces with the acquirer host 165, the issuer host 168, and/or the payment provider 170 server to facilitate transactions, according to various embodiments. For example, the payment provider server 170 may forward a transaction request to the payment network. The payment network may assess the transaction and may then send it to the acquirer host 165 or the issuer host 168 as a part of processing the transaction request. However, in some situations, a payment processor (e.g., the entity operating the payment provider server 170) may be penalized by the payment network if the payment processor sends an excess number of transactions that could have been determined by the payment processor to be fraudulent. As such, the payment processor may need to carefully screen the transactions in order to avoid the penalties. Since screening transactions may increase transaction latency, the payment processor is configured to screen some transactions with more scrutiny and other transactions with less scrutiny, according to some embodiments of the present disclosure. A network of communication devices, servers, and the like also may be established to relay payment related information among the different parties of a payment transaction.

Acquirer host 165 may be a server operated by an acquiring bank. An acquiring bank is a financial institution that accepts payments on behalf of merchants. For example, a merchant may establish an account at an acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

Issuer host 168 may be a server operated by an issuing bank or issuing organization of payment cards. The issuing banks may enter into agreements with various merchants to accept payments made using the payment cards. The issuing bank may issue a payment card to a user after a card account has been established by the user at the issuing bank. The user then may use the payment card to make payments at or with various merchants who agreed to accept the payment card.

Referring now to FIG. 2, another example context 200 in which outlier data may be generated is illustrated according to embodiments of the present disclosure. The context 200 may be associated with a cybersecurity environment. For example, a plurality of users 210-212 may be attempting to access electronic resources 220 of an entity via a network 240. The electronic resources 220 may include computing resources, memory storage space, network bandwidth, etc. In some embodiments, the electronic resources 220 may be provided via one or more computers, for example, computer servers. The servers may be operated by one or more entities, such as by a service provider similar to the payment provider 170 of FIG. 1, by a merchant entity operating the merchant server 140 of FIG. 1, or by a cybersecurity analyst. In some embodiments, the electronic resources 220 include resources associated with one or more user accounts. The network 240 may include a wireless network in some embodiments, or it may include a wired network in other embodiments. The network 240 may also be a part of the Internet, or a part of an intranet of an entity.

While many of the users attempting access to the electronic resources 220 may be legitimate users, such as users 211 and 212, some of the users may be malicious actors, such as the user 210. For example, the user 210 may be a computer hacker who may or may not have an actual account with the entity that provides the electronic resources 220, but who is nevertheless attempting to gain unauthorized access to the electronic resources 220. As non-limiting examples, the user 210 may engage in various methods of cyber-attacks, such as phishing, spoofing, sniffing, key logging, denial-of-service attacking, SQL injection, etc., and may utilize malicious tools such as computer viruses, computer worms, trojan horses, ransomware, spyware, etc.

In the example context 200, the attempted access made by the user 211 or the user 212 may be considered non-outlier events, but the attempted access made by the user 210 may be considered an outlier event. According to the various aspects of the present disclosure, a machine learning module 250 may be used to automatically detect and classify the unauthorized access to electronic resources 220 made by the user 210 as an outlier event. In some embodiments, the machine learning module 250 may be configured similarly as the machine learning module 198 of FIG. 1 discussed above. For example, similar to the machine learning module 198, the machine learning module 250 may be trained at least in part by synthetically-generated outlier data, which may be generated by varying the values of parameters that may include: an age of a user, a gender of a user, an occupation of a user, a type of a user account, a time of access, a type of VPN connection, a type of computer operating system, a browser type, a type of emulator(s) used, a presence of a firewall, etc.

It is understood that the aspects of the present disclosure are not limited to the example environments (in which outlier data can be generated) discussed above with reference to FIGS. 1-2. For example, another environment in which outlier data can be generated may be a healthcare environment, and the outlier events may include a diagnosis of a disease such as heart disease, cancer, diabetes, Alzheimer's, etc. The parameters may include a reading of a patient's biological functions, such as weight, height, heart rate, blood sugar level, blood oxygen level, brain activity, eyesight, hearing ability, sense of taste or smell, etc.

A further environment in which outlier data can be generated may be a natural phenomenon environment, and the outlier events may be weather-related events, such as a cold freeze or a heat wave (e.g., temperatures below a first threshold or exceeding a second threshold in a given time of the year), or natural disasters, such as a hurricane, a tornado, an earthquake, a volcanic eruption, a tsunami, a wildfire, etc. The parameters may include temperature, humidity, wind speed, wind direction, altitude, satellite positioning coordinates, water levels, type of land, etc.

Another environment in which outlier data can be generated may be a financial markets environment, and the outlier events may include a trading volume of a specified asset (e.g., a commodity (e.g., precious metals, lumber, grains) or a stock of a company) exceeding a specified threshold, a stock price volatility above a specified threshold (e.g., a variation in price greater than 20% on a given day), the issuance of new stock shares for trading, the suspension of trading of a stock, etc. The parameters may include name of the commodity/stock, price of the commodity/stock, company/entity owning the commodity/stock, the exchange on which the commodity/stock is traded, a trading volume of the commodity/stock, the date and/or time of the trades, etc.

Yet another environment in which outlier data can be generated may be an electrical power grid management environment, and the outlier events may include an unexpected surge in electrical power consumption exceeding a specified threshold in a given electrical power grid. The parameters may include the location of electrical power grid, the amount of electrical power consumption, the price per unit of power consumption, time of year, etc.

Other environments that could generate outlier data are not specifically discussed herein for reasons of simplicity.

Referring now to FIG. 3, and example process flow 300 is illustrated. The process flow generates synthetic outlier data and uses the synthetically generated outlier data to train a machine learning model. The process flow may be performed by executing steps 310-380. The details of the execution of each of the steps 310-380 will now be discussed below in more detail.

In a step 310 of the process flow 300, historical outlier data is collected. In the context of electronic commerce or cybersecurity, historical outlier data may include fraud trend data or cyber-attack data, respectively. In other contexts, the historical outlier data may include data corresponding to other types of outlier events, such as a disease in a healthcare environment, a natural disaster in a natural phenomenon environment, a volatility exceeding a first threshold in a financial markets environment, or an unexpected power surge exceeding a second threshold in an electrical power grid environment, etc.

Regardless of the type of environment or the type of historical outlier data collected, it is understood that each instance of the historical outlier data may have well-defined values associated with the parameters. Non-limiting examples of the various types of parameters may include: monetary amount of a transaction, type of the transaction, items/goods involved in the transaction, geographical location of transaction, VPN connection information, device type information, device identification information, age of a user, gender of a user, occupation of a user, type of a user account, time of access, type of computer operating system, browser type, use of emulators, presence of a firewall, a reading of a patient's biological functions (e.g., weight, height, heart rate, blood sugar level, blood oxygen level, brain activity, eye sight, hearing ability, sense of taste or smell), temperatures, humidity levels, wind speed, wind direction, water levels, type of land, name of a commodity/stock, price of the commodity/stock, company/entity owning the commodity/stock, an exchange on which the commodity/stock is traded, a trading volume of the commodity/stock, a date and/or time of the trades, a location of electrical power grid, an amount of electrical power consumption, the price per unit of power consumption, time of year, etc. The historical outlier data may also be labeled as organic outlier data, so as to differentiate it from the outlier data that will be synthetically generated as discussed below.

In a step 320 of the process flow 300, synthetic outlier data is generated. In some embodiments, an oversampling technique, such as a Synthetic Minority Oversampling Technique (SMOTE), is used to generate the synthetic outlier data. The SMOTE technique is performed to create a plurality of (e.g., hundreds or thousands, or more) outlier events that are similar, but not identical to, any of the historical outlier events that have actually occurred. For example, the historical outlier events may be embedded in a vector space, such that each of them may be represented mathematically in the vector space. In some embodiments, the vector space may be a multi-dimensional vector space, where each dimension corresponds to a perspective parameter of the event. Based on the values of the parameters of each of the historical outlier events, each of the historical outlier events may have a corresponding location in the vector space. In order to generate the synthetic outlier events, the values of the parameters of the historical outlier events may be varied. Theoretically, an infinite number of hypothetical outlier events that are similar to the historical outlier events may be generated in the vector space.

In some embodiments, a synthetic outlier event may be generated by selecting a particular historical event and varying a value of a first parameter of the selected historical event, while maintaining values of at least a subset of the remaining parameters of the selected historical event. The varying of the value of the first parameter is performed in a manner such that the hypothetical event is different from any of the actual historical events whose data is collected in step 310. As a simplified example, one historical outlier event may be a request to conduct an electronic transaction, where the request has been deemed to be fraudulent. As a simple non-limiting example, the parameters of such an event may include a geographical location from which the request is originated, a VPN connection type, and a type of operating system emulator. The values of these parameters for the particular selected historical event are such that the geographical location is Malaysia, the VPN connection type is a European VPN connection, and the type of operating system emulator is an Android emulator. Based on the above, a hypothetical outlier event may be generated by changing the parameter values of the geographical location, the VPN connection type, or the type of operating system emulator. For example, a first hypothetical outlier event may be created by switching the geographical location from Malaysia to Indonesia, while maintaining the VPN connection type (e.g., Europe VPN connection) and the type of operating system emulator (e.g., Android emulator). As another example, a second hypothetical outlier event may be created by switching the type of operating system emulator from Android to IOS, while maintaining the geographical location (e.g., Malaysia) of the request origination and the VPN connection type (e.g., Europe VPN connection).

In a step 330 of the process flow 300, the historical outlier data gathered from step 310 and the synthetically-generated outlier data from step 320 are combined into a unified dataset. The unified dataset may also include non-outlier data. For example, non-outlier data may be collected on a periodic basis (e.g., every day, every week, every month, every year, etc.) or on a non-periodic basis and added to the unified dataset. Since the number of instances corresponding to the synthetically-generated outlier data can be controlled by step 320, it is possible to configure a ratio between the outlier data and non-outlier data in the unified dataset. In other words, an exact amount of the synthetic outlier data may be used as the subset of the synthetic outlier data to be combined into the unified dataset, such that a specified ratio is achieved between a total amount of outlier data and a total amount of non-outlier data in the unified dataset.

In some embodiments, the ratio can be determined based on an evaluation of a precision percentage or a recall percentage of the trained machine learning model (obtained from step 340 discussed below). A precision percentage may refer to a percentage of actual outlier events out of events that have been classified (e.g., predicted) as outlier events by the machine learning model, or a percentage of actual non-outlier events out of events that have been classified (e.g., predicted) as non-outlier events by the machine learning model, or a combination thereof. In other words, the precision percentage may involve the analysis: for all the events that the machine learning model predicted to be outlier events or non-outlier events, how many of them were actually outlier events or non-outlier events?

Meanwhile, a recall percentage may refer to a percentage of the number of correctly-classified outlier events out of a total number of actual outlier events. In other words, the recall percentage may involve the following analysis: out of all the known actual outlier events, how many of these events did the machine learning model correctly predict?

In any case, a value of the ratio (between the total amount of outlier data and the total amount of non-outlier data in the unified dataset) is configured in a manner to optimize the precision percentage and/or the recall percentage of the trained machine learning model. As a simplified non-limiting example, the ratio may be configured to be at 5%, 10%, 15%, 20%, 25%, 30%, 35%, and 40%, respectively. The step 330 may be performed at each of the above ratios, and the results of the trained machine learning model is evaluated accordingly. A determination may be made, based on the precision percentage and/or the recall percentage of the trained machine learning model, that the machine learning model trained using a 20% ratio yielded the best precision percentage and/or the recall percentage. As such, 20% may be used as a target ratio between the total amount of outlier data and the total amount of non-outlier data in the unified dataset going forward in this simplified example.

In a step 340 of the process flow 300, a machine learning model is trained using the unified dataset obtained from step 330. In various embodiments, the machine learning model may include a tree-based machine learning model, a neural network based machine learning model, or a deep learning machine model. In some embodiments, the training of the machine learning model involves an Out-of-Time (OOT) validation period. For example, the machine learning model may be trained for an initial period of time (e.g., four months). thereafter, the performance of the trained machine learning model may be evaluated in a separate time frame (referred to as a test period) and another time period that is the OOT validation period. The OOT validation period is separate and different from the initial training period and the test period. In the OOT validation period, the machine learning model is instructed to make predictions (e.g., by classifying data as either outlier data or non-outlier data), while the actual outlier data and actual non-outlier data are both already known. As such, it is possible to calculate the precision percentage and the recall percentage discussed above. Again, the ratio discussed above may be configured to optimize the precision percentage and/or the recall percentage.

In a step 350 of the process flow 300, the importance of each of the parameters is determined. For example, the step 350 determines the amount of contribution made by each parameter in the machine learning model's classification of an event (e.g., as either outlier or non-outlier). In some embodiments, the execution of the step 350 involves running a SHapley Additive explanations (SHAP) model. In that regard, SHAP utilizes a game theory approach to explain an output of a particular machine learning model. In the context of the present disclosure, the SHAP model is used to define what the most important parameters (of the historical or synthetic events) are for the machine learning model to learn the difference(s) between the outlier events and non-outlier events. In some embodiments, the contribution from each individual parameter is calculated separately. For example, the machine learning model may be trained while leaving some of the parameters out. This allows a determination to be made as to how crucial the left-out parameter is for the machine learning model to get accurate results. In some embodiments, the importance of every parameter is ranked, or otherwise represented with a numerical value.

In a step 360 of the process flow 300, new data may be accessed by the trained machine learning model, and the trained machine learning model may output scores based on the new data. A simplified example of step 350 may be illustrated using Table 1 and Table 2 below. Table 1 includes two different new events corresponding to event IDs 125124 and 1234142, respectively. Each of these two events comprise parameters that include: country (e.g., the geographical location where the event was originated), Screen_resolution (e.g., the screen resolution of the user device associated with the event), Email_domain (e.g., the web domain of the email address associated with the event), and ISP (e.g., the Internet service provider of the user device associated with the event).

TABLE 1

| Event ID | Classification Score |
|---|---|
| 125124 | 0.15 |
| 1234142 | 0.9 |

TABLE 2
(for event ID 125124)

| Parameter | Importance Score |
|---|---|
| Country | 0.34 |
| Screen_resolution | 0.24 |
| Email_domain | 0.1 |
| ISP | 0.04 |

As shown in Table 1, the trained machine learning model may output a classification score of 0.15 for the event corresponding to the event ID 125124, and a classification score of 0.9 for the event corresponding to the event ID 1234142. The classification score may be compared against a specified threshold score to classify the respective event as either an outlier event or a non-outlier event. For example, the specified threshold scorer may be 1, such that event scores there are less than 1 are classified as outlier events, and event scores that are greater than 1 are classified as non-outlier events. In that case, since both of the events in Table 1 have a classification score that is less than 1, they may both be classified as outlier events in this simplified example.

As shown in Table 2, for the event corresponding to the event ID 125124, the parameters “Country”, “Screen_resolution”, “Email_domain”, and “ISP” are assigned with importance scores of 0.34, 0.24, 0.1, and 0.04, respectively. These importance scores are numerical representations of the importance of each of these parameters in the event corresponding to the event ID 125124 being classified as an outlier event. The importance scores may serve a useful role in providing an explanation to an entity as to why the entity's request is approved or denied. For example, the event corresponding to the event ID 125124 may be a request for a user to access an account of the user. Since the machine learning model has classified this event as an outlier event (e.g., a malicious attempt to access the user's account) based on the classification score not meeting the specified threshold score, the request from the user is denied. The user (who could be a legitimate user) may ask a customer service representative why the request was denied. The customer service representative may access the table (e.g., Table 2) containing the importance scores and convey to the user that the country in which the request was originated, as well as the screen resolution of the user device, were among the biggest factors in the user's request being denied. The customer service representative may also make a recommendation to the user to change the country of origin and/or the screen resolution of the user device in order to improve the odds of the users request being approved. The user may then change one or both of these parameters, for example, by changing the screen resolution of the user device. Thereafter, the user may resubmit the request. Based on the user's new request, the machine learning model may output a new classification score again, and the event may now have a higher likelihood of being classified as a non-outlier event, in which case the user's request may be granted.

It is understood that the threshold score associated with Table 1 for classifying outlier events and non-outlier events need not be 1. For example, a threshold score may be 0.5, such that event scores there are less than 0.5 are classified as outlier events, and event scores that are greater than 0.5 are classified as non-outlier events. In that case, the event corresponding to the event ID 125124 may be classified as an outlier event, but the event corresponding to the event ID 1234142 may be classified as a non-outlier event. It is also understood that Table 2 may include any number of parameters and their respective importance scores, even though only four parameters are illustrated in Table 2 in this simplified example.

In a step 370 of the process flow 300, new outlier trends are accessed. Specifically, after the initial training and running of the machine learning model based on steps 310-360, new outlier trends may occur. For example, in the context of electronic transactions, these new outlier trends may correspond to new trends to conduct fraudulent transactions. The data corresponding to the new outlier trends may contain valuable information, and therefore, it is worthwhile to retrain the machine learning model based on this new data.

In that regard, a step 380 of the process flow 300 retrains the machine learning model based on the new outlier trend data accessed from step 370. The step 380 may also be referred to as a Rapid Model Refresh (RMR). In some embodiments, the retraining of the machine learning model is based on the new outlier trend data as well as new non-outlier trend data, but it may not rely on any synthetically-generated outlier data. In other embodiments, however, the retraining of the machine learning model is based on the new outlier trend data, the new non-outlier trend data, as well as synthetically-generated outlier data, which may be generated using a process similar to that described above in association with step 320.

Regardless of how the machine learning model is retrained, the results produced by the retrained machine learning model may be compared against the results produced by the initially-trained machine learning model to determine which model is better. For example, a plurality of events that are known to be either outlier events or non-outlier events are sent to the initially-trained machine learning model and to the retrained machine learning model for classification. The initially-trained machine learning model may attempt to classify these events as either outlier events or non-outlier events, as does the retrained machine learning model. In the end, one of these models will produce more accurate classification results than the other model, and the more accurate model may be adopted as the model to classify data in a production environment. Of course, the retraining of the machine learning model may occur from time to time, for example, on a periodic basis. Accordingly, the machine learning model used in the production environment may also be updated from time to time.

FIG. 4 is a flowchart illustrating a method 400 for performing a machine learning process according to various aspects of the present disclosure. In some embodiments, the various steps of the method 400, which are described in greater detail below, may be performed by a single system. The single system may include one or more computer processors and a non-transitory computer-readable medium having stored thereon instructions that are executable by the one or more processors to cause the system to perform the steps of the method 400. In some embodiments, the system may include a computer of an entity, such as a payment provider, an operator of an electronic transaction platform, a cybersecurity platform, a healthcare professional, or a business analyst, etc. In some embodiments, at least some of the steps of the method 400 may be performed by the machine learning module 198 or the machine learning module 250 discussed above.

The method 400 includes a step 410 to access historical outlier data corresponding to a plurality of user accounts. The historical outlier data may include data associated with outlier events in a specified environment. In each of the specified environments, the historical outlier data may have a respective set of parameters. For example, the specified environment may be an electronic commerce environment, the outlier events may include fraudulent transactions. The parameters may include an amount of a transaction, a type of a transaction, a type of items/goods involved in the transaction, a geographical location of transaction, VPN connection information, device type information, device identification information, etc.

As another example, the specified environment may be an information security environment, and the outlier events may include malicious online activities, such as computer hacking or otherwise unauthorized access to one or more users' accounts. The parameters may include an age of a user, a gender of a user, an occupation of a user, a type of a user account, a time of access, a VPN connection information, a type of computer operating system, a browser type, a use of emulators, a presence of a firewall, etc.

As yet another example, the specified environment may be a healthcare environment, and the outlier events may include a diagnosis of a disease such as heart disease, cancer, diabetes, Alzheimer's, etc. The parameters may include a reading of a patient's biological functions, such as weight, height, heart rate, blood sugar level, blood oxygen level, brain activity, eye sight, hearing ability, sense of taste or smell, etc.

As a further example, the specified environment may be a natural phenomenon environment, and the outlier events may be weather-related events, such as a cold freeze or a heat wave (e.g., temperatures below a first threshold or exceeding a second threshold in a given time of the year), or natural disasters, such as a hurricane, a tornado, an earthquake, a volcanic eruption, a tsunami, a wildfire, etc. The parameters may include temperatures, humidity, wind speed, wind direction, geographical locations, water levels, type of land, etc.

As another example, the specified environment may be a financial markets environment, and the outlier events may include a trading volume of a specified asset (e.g., a commodity or a stock of a company) exceeding a specified threshold, a stock price volatility above a specified threshold (e.g., a variation in price greater than 20% on a given day), the issuance of new stock shares for trading, the suspension of trading of a stock, etc. The parameters may include a name of the commodity/stock, a price of the commodity/stock, company/entity owning the commodity/stock, an exchange on which the commodity/stock is traded, a trading volume of the commodity/stock, a date and/or time of the trades, etc.

As a further example, the specified environment may be an electrical power grid management environment, and the outlier events may include an unexpected surge in electrical power consumption exceeding a specified threshold in a given electrical power grid. The parameters may include a location of electrical power grid, an amount of electrical power consumption, a price per unit of power consumption, a time of year, etc.

The method 400 includes a step 420 to generate synthetic outlier data associated with the plurality of user accounts. In some embodiments, the synthetic outlier data is generated based on the historical outlier data using a minority oversampling technique, such as a Synthetic Minority Oversampling Technique. In some embodiments, the generation of the synthetic outlier data is performed based on a determination that an outlier trend in the plurality of user accounts has occurred or is occurring, but that an amount of the historical outlier data is insufficient to train a machine learning model.

In some embodiments, the synthetic outlier data is generated by varying the values of one or more of the parameters of the historical outlier data. For example, an instance of the historical outlier data corresponding to a particular historical event is selected. Thereafter, a hypothetical event may be generated at least in part by varying a value of the first parameter of the selected instance while maintaining values of at least a subset of the remaining parameters of the selected instance. As a simplified example, one historical outlier event may be a request to conduct a transaction, where the request originated from Malaysia, and a VPN connection to Europe is used, and an Android emulator is also used. A hypothetical outlier event may be generated based on this actual historical outlier event, for example, by changing the location of to request a registration from Malaysia to Indonesia, while maintaining the VPN connection to Europe and the Android emulator. Note that in some embodiments, the hypothetical event may be different from any actual historical event corresponding to the historical outlier data. In other words, the hypothetical event has not happened yet, and its parameters are not identical to any of the actual events that have happened already, according to these embodiments.

The method 400 includes a step 430 to combine the historical outlier data (accessed in step 410), at least a subset of the synthetic outlier data (generated from step 420), and historical non-outlier data associated with the plurality of user accounts into a unified dataset. Note that the historical non-outlier data may correspond to historical events that were not outliers. For example, in an electronic transaction context, the historical non-outlier data may correspond to regular transactions where no fraud has occurred. In some embodiments, a determination is made with respect to an amount of the synthetic outlier data to be used as the subset of the synthetic outlier data to be combined, such that a specified ratio is achieved between a total amount of outlier data and a total amount of non-outlier data. For example, a precision percentage or a recall percentage of the trained machine learning model may be evaluated. In that case, the specified ratio is determined based on the precision percentage or the recall percentage of the trained machine learning model.

The method 400 includes a step 440 to train a machine learning model with the unified dataset obtained from step 430. In various embodiments, the machine learning model may include a tree-based machine learning model, a neural network based machine learning model, or a deep learning machine model. Regardless of the type of machine learning models used, the training of the machine learning model will allow the machine learning model to learn what type of events should be classified as outlier events, and what other types of events should be classified as non-outlier events, based on the parameters of the events.

The method 400 includes a step 450 to classify, based on the trained machine learning model, new data as either outlier data or non-outlier data in the plurality of user accounts. For example, once the machine learning model from step 440 has been fully trained, new data corresponding to newly occurred events may be accessed by the trained machine learning model. The new data may also have various parameters similar to the parameters of the historical events and synthetically-generated events (regardless of whether the events are outlier events or not). Based on the parameter values of the new data, the trained machine learning model can determine whether each new event is an outlier event or a non-outlier event in a specified environment. Note that due to the amount of synthetically-generated hypothetical data being available to train the machine learning model, the machine learning model is able to accurately and quickly determine whether the events corresponding to the new data should be classified has outlier events.

The method 400 includes a step 460 to retrain the machine learning model based on additional outlier data received after an initial training of the machine learning model. For example, after the machine learning model has been initially trained in step 440 and has been used for a period of time to classify new data in step 450, new outlier trends may emerge. For example, in the electronic transaction environment, new trends for perpetrating fraud may emerge. As such, it would be beneficial for the machine learning model to take into account of the new fraud trends. In some embodiments, at specified time intervals (e.g., every week, every month, every year, etc.), the machine learning model may be retrained based on the new data received after the initial training of the machine learning model. In some embodiments, the retraining of the machine learning model may incorporate some of the elements of steps 410-440 discussed above.

The method 400 includes a step 470 to compare a performance of the retrained machine learning model with the performance of the initially-trained machine learning model. For example, when data comes in that needs to be classified as either outlier data or non-outlier data, a first result may be produced by the retrained machine learning model from step 460, and the second result may be produced by the initially-trained machine learning model from step 440. According to step 470, the first result is compared with the second result to see which result is more accurate in the classification of the new data.

The method 400 includes a step 480 to select, based on the comparison result obtained from step 470, the retrained machine learning model or the initially-trained machine learning model to perform the classifying. In other words, if the initially-trained machine learning model is still more accurate in the outlier classification of new data, then the initially-trained machine learning model will be used as the model to perform the outlier classification going forward. However, if the retrained machine learning model is more accurate in the outlier classification of new data, then the retrained machine learning model will be used as the model to perform the outlier classification going forward.

It is understood that additional method steps may be performed before, during, or after the steps 400-480 discussed above. For example, the method 400 may include a step to evaluate an importance of each parameter of the plurality of parameters of the outlier data in the training of the machine learning model. In some embodiments, the evaluation is performed via the user of a Shapley Additive Explanation (SHAP) model. In some embodiments, the evaluation may produce a score for the importance of each of the parameters. This may be useful when a customer service agent needs to explain to a user why the user's request to conduct a transaction or to access a specified electronic resource has been denied. For example, the customer service agent may explain to the user-who is making a legitimate request—that it is the user's use of a European VPN connection that is causing the denial of the request. The user may then switch the VPN connection and resubmit the request, which will then likely be classified as a non-outlier event and therefore granted. Other steps of the method 400 may also be performed, but they are not specifically discussed herein for reasons of simplicity.

FIG. 5 is a block diagram of a computer system 500 suitable for implementing various methods and devices described herein, for example, the machine learning module 198, the user device 110, the merchant server 140, or the payment provider server 170. In various implementations, the devices capable of performing the steps may comprise a network communications device (e.g., mobile cellular phone, laptop, personal computer, tablet, etc.), a network computing device (e.g., a network server, a computer processor, an electronic communications interface, etc.), or another suitable device. Accordingly, it should be appreciated that the devices capable of implementing the machine learning module 198 or the machine learning module 250 and the various method steps of the method 400 discussed below (or the user device 110, the merchant server 140, or the payment provider server 170) may be implemented as the computer system 500 in a manner as follows.

In accordance with various embodiments of the present disclosure, the computer system 500, such as a network server or a mobile communications device, includes a bus component 502 or other communication mechanisms for communicating information, which interconnects subsystems and components, such as a computer processing component 504 (e.g., processor, micro-controller, digital signal processor (DSP), etc.), system memory component 506 (e.g., RAM), static storage component 508 (e.g., ROM), disk drive component 510 (e.g., magnetic or optical), network interface component 512 (e.g., modem or Ethernet card), display component 514 (e.g., cathode ray tube (CRT) or liquid crystal display (LCD)), input component 516 (e.g., keyboard), cursor control component 518 (e.g., mouse or trackball), and image capture component 520 (e.g., analog or digital camera). In one implementation, disk drive component 510 may comprise a database having one or more disk drive components.

In accordance with embodiments of the present disclosure, computer system 500 performs specific operations by the processor 504 executing one or more sequences of one or more instructions contained in system memory component 506. Such instructions may be read into system memory component 506 from another computer readable medium, such as static storage component 508 or disk drive component 510. In other embodiments, hard-wired circuitry may be used in place of (or in combination with) software instructions to implement the present disclosure. In some embodiments, the various components of the machine learning module 198 or the machine learning module 250 may be in the form of software instructions that can be executed by the processor 504 to automatically perform context-appropriate tasks on behalf of a user.

Logic may be encoded in a computer readable medium, which may refer to any medium that participates in providing instructions to the processor 504 for execution. Such a medium may take many forms, including but not limited to, non-volatile media and volatile media. In one embodiment, the computer readable medium is non-transitory. In various implementations, non-volatile media includes optical or magnetic disks, such as disk drive component 510, and volatile media includes dynamic memory, such as system memory component 506. In one aspect, data and information related to execution instructions may be transmitted to computer system 500 via a transmission media, such as in the form of acoustic or light waves, including those generated during radio wave and infrared data communications. In various implementations, transmission media may include coaxial cables, copper wire, and fiber optics, including wires that comprise bus 502.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. These computer readable media may also be used to store the programming code for the machine learning module 198 discussed above.

In various embodiments of the present disclosure, execution of instruction sequences to practice the present disclosure may be performed by computer system 500. In various other embodiments of the present disclosure, a plurality of computer systems 500 coupled by communication link 530 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 500 may transmit and receive messages, data, information and instructions, including one or more programs (i.e., application code) through communication link 530 and communication interface 512. Received program code may be executed by computer processor 504 as received and/or stored in disk drive component 510 or some other non-volatile storage component for execution. The communication link 530 and/or the communication interface 512 may be used to conduct electronic communications between the machine learning module 198 (or the machine learning module 250) and external devices, for example with the user device 110, with the merchant server 140, or with the payment provider server 170, depending on exactly where the machine learning module 198 (or the machine learning module 250) is implemented.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein. It is understood that at least a portion of the machine learning module 198 (or the machine learning module 250) may be implemented as such software code.

As discussed above, machine learning is used to learn and predict which events are outlier events in a given environment. In some embodiments, the machine learning may be performed at least in part via an artificial neural network, which may be used to implement the machine learning module 198 of FIG. 1 or the machine learning module 250 of FIG. 2. In that regard, FIG. 6 illustrates an example artificial neural network 600 as one type of machine learning model. As shown, the artificial neural network 600 includes three layers—an input layer 602, a hidden layer 604, and an output layer 606. Each of the layers 602, 604, and 606 may include one or more nodes. For example, the input layer 602 includes nodes 608-614, the hidden layer 604 includes nodes 616-618, and the output layer 606 includes a node 622. In this example, each node in a layer is connected to every node in an adjacent layer. For example, the node 608 in the input layer 602 is connected to both of the nodes 616-618 in the hidden layer 604. Similarly, the node 616 in the hidden layer is connected to all of the nodes 608-614 in the input layer 602 and the node 622 in the output layer 606. Although only one hidden layer is shown for the artificial neural network 600, it has been contemplated that the artificial neural network 600 used to implement the machine learning module 260, and the machine learning module 260 may include as many hidden layers as necessary.

In this example, the artificial neural network 600 receives a set of input values and produces an output value. Each node in the input layer 602 may correspond to a distinct input value. For example, when the artificial neural network 600 is used to implement the machine learning modules 198 or 250, each node in the input layer 602 may correspond to a distinct parameter of an event.

In some embodiments, each of the nodes 616-618 in the hidden layer 604 generates a representation, which may include a mathematical computation (or algorithm) that produces a value based on the input values received from the nodes 608-614. The mathematical computation may include assigning different weights to each of the data values received from the nodes 608-614. The nodes 616 and 618 may include different algorithms and/or different weights assigned to the data variables from the nodes 608-614 such that each of the nodes 616-618 may produce a different value based on the same input values received from the nodes 608-614. In some embodiments, the weights that are initially assigned to the features (or input values) for each of the nodes 616-618 may be randomly generated (e.g., using a computer randomizer). The values generated by the nodes 616 and 618 may be used by the node 622 in the output layer 606 to produce an output value for the artificial neural network 600. When the artificial neural network 600 is used to implement the machine learning module 260, the output value produced by the artificial neural network 600 may indicate a likelihood of an event (e.g., a probability that a particular event is an outlier event).

The artificial neural network 600 may be trained by using training data. For example, the training data herein may include historical outlier data, historical non-outlier data, as well as the synthetically-generated outlier data according to the aspects of the present disclosure. By providing training data to the artificial neural network 600, the nodes 616-618 in the hidden layer 604 may be trained (adjusted) such that an optimal output (e.g., determining a value for a threshold) is produced in the output layer 606 based on the training data. By continuously providing different sets of training data, and penalizing the artificial neural network 600 when the output of the artificial neural network 600 is incorrect (e.g., when the predicted classification (e.g., outlier VS non-outlier) of an event is inconsistent with the actual classification of the event, etc.), the artificial neural network 600 (and specifically, the representations of the nodes in the hidden layer 604) may be trained (adjusted) to improve its performance in data classification. Adjusting the artificial neural network 600 may include adjusting the weights associated with each node in the hidden layer 604.

Although the above discussions pertain to an artificial neural network as an example of machine learning, it is understood that other types of machine learning methods may also be suitable to implement the various aspects of the present disclosure. For example, gradient boosting may be used to implement the machine learning, which is a machine learning technique for regression and classification problems. Gradient boosting generates a prediction model, which could be in the form of decision trees. As another example, support vector machines (SVMs) may be used to implement machine learning. SVMs are a set of related supervised learning methods used for classification and regression. A SVM training algorithm—which may be a non-probabilistic binary linear classifier—may build a model that predicts whether a new example falls into one category or another. As another example, Bayesian networks may be used to implement machine learning. A Bayesian network is an acyclic probabilistic graphical model that represents a set of random variables and their conditional independence with a directed acyclic graph (DAG). The Bayesian network could present the probabilistic relationship between one variable and another variable. Other types of machine learning algorithms are not discussed in detail herein for reasons of simplicity.

FIG. 7 illustrates an example cloud-based computing architecture 700, which may also be used to implement various aspects of the present disclosure. The cloud-based computing architecture 700 includes a mobile device 704 (e.g., the user device 110 of FIG. 1) and a computer 702 (e.g., the merchant server 140 or the payment provider server 170), both connected to a computer network 706 (e.g., the Internet or an intranet). In one example, a consumer has the mobile device 704 that is in communication with cloud-based resources 708, which may include one or more computers, such as server computers, with adequate memory resources to handle requests from a variety of users. A given embodiment may divide up the functionality between the mobile device 704 and the cloud-based resources 708 in any appropriate manner. For example, an app on mobile device 704 may perform basic input/output interactions with the user, but a majority of the processing may be performed by the cloud-based resources 708. However, other divisions of responsibility are also possible in various embodiments. In some embodiments, using this cloud architecture, the machine learning module 198 may reside on the merchant server 140 or the payment provider server 170, but its functionalities can be accessed or utilized by the mobile device 704, or vice versa.

The cloud-based computing architecture 700 also includes the personal computer 702 in communication with the cloud-based resources 708. In one example, a participating merchant or consumer/user may access information from the cloud-based resources 708 by logging on to a merchant account or a user account at computer 702. The system and method for performing the machine learning process as discussed above may be implemented at least in part based on the cloud-based computing architecture 700.

It is understood that the various components of cloud-based computing architecture 700 are shown as examples only. For instance, a given user may access the cloud-based resources 708 by a number of devices, not all of the devices being mobile devices.

Similarly, a merchant or another user may access the cloud-based resources 708 from any number of suitable mobile or non-mobile devices. Furthermore, the cloud-based resources 708 may accommodate many merchants and users in various embodiments.

Based on the above discussions, systems and methods described in the present disclosure offer several significant advantages over conventional methods and systems. It is understood, however, that not all advantages are necessarily discussed in detail herein, different embodiments may offer different advantages, and that no particular advantage is required for all embodiments. One advantage is improved functionality of a computer. For example, the present disclosure uses machine learning to determine the classification of events, for example, as either outlier events or non-outlier events. For machine learning models to perform accurately, a large amount of training data is needed. However, since outlier trends may rapidly shift over time, the amount of training data that can be used to train the machine learning model may not be sufficient. According to the various aspects of the present disclosure, the outlier data that can be used as training data can be synthetically generated, which can then simulate real outlier trends that may develop at a later time. As such, the machine learning model can make more accurate predictions. In addition, the more accurate predictions made by the machine learning models herein will help avoid the unnecessary processing of outlier events, for example, fraudulent transactions that should not have been processed in the first place. By doing so, the present disclosure reduces the waste of electronic resources associated with transactions that should be declined. In other words, the processing of fraudulent transactions will necessarily result in the consumption of computer processing power and/or network communication bandwidth. If these transactions are accurately classified as fraudulent transactions, then the consumption of the computer processing power and/or network communication bandwidth would be reduced or eliminated. Therefore, by accurately classifying outlier events, the present disclosure helps to conserve computer processing power and/or network communication bandwidth, and as such improves the functionality of a computer.

The inventive ideas of the present disclosure are also integrated into a practical application, for example into the machine learning module 198 or the machine learning module 250 discussed above. Such a practical application can automatically predict the likelihood of a particular event being a regular non-outlier event or an outlier event. In addition, such a practical application can also reveal the importance of each of the parameters of an event when the event is classified as an outlier event. This is particularly helpful when a customer service agent needs (or wishes) to provide a rationale to an entity as to why the entity's request is classified as an outlier event and therefore denied. When the entity is otherwise legitimate, the rationale may offer the entity a chance to adjust one or more of the important parameters, which may then allow the entity's request to be reclassified as being a non-outlier event and therefore granted.

It should be appreciated that like reference numerals are used to identify like elements illustrated in one or more of the figures, wherein these labeled figures are for purposes of illustrating embodiments of the present disclosure and not for purposes of limiting the same.

One aspect of the present disclosure involves a machine learning method that includes the following steps: accessing historical outlier data corresponding to a plurality of user accounts, wherein the historical outlier data comprises a plurality of parameters; generating, based on the historical outlier data and using a minority oversampling technique, synthetic outlier data associated with the plurality of user accounts; combining the historical outlier data, at least a subset of the synthetic outlier data, and historical non-outlier data associated with the plurality of user accounts into a unified dataset; training a machine learning model with the unified dataset; and classifying, based on the trained machine learning model, new data as either outlier data or non-outlier data in the plurality of user accounts.

Another aspect of the present disclosure involves a system that includes a non-transitory memory and one or more hardware processors coupled to the non-transitory memory and configured to read instructions from the non-transitory memory to cause the system to perform operations comprising: accessing first data corresponding to a plurality of historical outlier events that have occurred in a specified environment, wherein each of the historical outlier events is associated with a plurality of different types of parameters; accessing second data corresponding to a plurality of synthetically-generated outlier events in the specified environment, wherein the synthetically-generated outlier events are generated at least in part by applying a minority oversampling technique on the first data; accessing third data corresponding to a plurality of historical non-outlier events that have occurred in the specified environment; combining at least subsets of the first data, the second data, and the third data into a combined dataset; training a machine learning model with the combined dataset; and determining, based on the trained machine learning model, whether a new event in the specified environment is an outlier event.

Yet another aspect of the present disclosure involves a non-transitory machine-readable medium having stored thereon machine-readable instructions executable to cause a machine to perform operations comprising: accessing historical outlier data corresponding to a plurality of user accounts, wherein the historical outlier data comprises a plurality of parameters, and wherein an amount of the historical outlier data is insufficient to train a machine learning model; generating, based on the historical outlier data and using a minority oversampling technique, synthetic outlier data associated with the plurality of user accounts; generating an aggregated dataset based on at least a subset of the historical outlier data, at least a subset of the synthetic outlier data, and at least a subset of historical non-outlier data associated with the plurality of user accounts; training a machine learning model with the aggregated dataset; accessing new data after the machine learning model has been trained, the new data containing a request to access a resource; and determining, based on the trained machine learning model, whether the new data should be classified as outlier data or non-outlier data.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
accessing historical outlier data corresponding to a plurality of user accounts, wherein the historical outlier data comprises a plurality of parameters;
generating, based on the historical outlier data and using a minority oversampling technique, synthetic outlier data associated with the plurality of user accounts;
combining the historical outlier data, at least a subset of the synthetic outlier data, and historical non-outlier data associated with the plurality of user accounts into a unified dataset;
training a machine learning model with the unified dataset; and
classifying, based on the trained machine learning model, new data as either outlier data or non-outlier data in the plurality of user accounts.

2. The method of claim 1, further comprising:
retraining the machine learning model based on additional outlier data received after an initial training of the machine learning model;
comparing a performance of the retrained machine learning model with a performance of the initially trained machine learning model; and
selecting, based on a result of the comparing, one of the retrained machine learning model or the initially trained machine learning model to perform the classifying.

3. The method of claim 1, further comprising: evaluating, based on a Shapley Additive Explanation (SHAP) model, an importance of each parameter of the plurality of parameters in the training of the machine learning model.

4. The method of claim 1, wherein the generating the synthetic outlier data is performed based on a determination that an outlier trend in the plurality of user accounts has occurred or is occurring, but that an amount of the historical outlier data is insufficient to train the machine learning model.

5. The method of claim 1, wherein the generating the synthetic outlier data is performed at least in part by varying values of one or more of the plurality of parameters of the historical outlier data.

6. The method of claim 5, wherein the varying comprises:
selecting an instance of the historical outlier data corresponding to a particular historical event; and
generating a hypothetical event at least in part by varying a value of a first parameter of the selected instance while maintaining values of at least a subset of remaining parameters of the selected instance, wherein the hypothetical event is different from any actual historical event corresponding to the historical outlier data.

7. The method of claim 1, further comprising: determining an amount of the synthetic outlier data to be used as the subset of the synthetic outlier data to be combined, such that a specified ratio is achieved between a total amount of outlier data and a total amount of non-outlier data.

8. The method of claim 7, further comprising: evaluating a precision percentage or a recall percentage of the trained machine learning model, wherein the specified ratio is determined based on the precision percentage or the recall percentage of the trained machine learning model.

9. The method of claim 1, wherein the classifying is performed in response to a request to access a specified resource, wherein the new data is associated with the request, and wherein the method further comprises:
denying access to the specified resource when the new data is classified as the outlier data; or
granting access to the specified resource when the new data is classified as the non-outlier data.

10. The method of claim 9, further comprising: when the access to the specified resource is denied, providing, to entity that issued the request, a reason why the access is denied, wherein the providing is based at least in part on the trained machine learning model.

11. A system comprising:
a processor; and
a non-transitory computer-readable medium having stored thereon instructions that are executable by the processor to cause the system to perform operations comprising:
accessing first data corresponding to a plurality of historical outlier events that have occurred in a specified environment, wherein each of the historical outlier events is associated with a plurality of different types of parameters;
accessing second data corresponding to a plurality of synthetically-generated outlier events in the specified environment, wherein the synthetically-generated outlier events are generated at least in part by applying a minority oversampling technique on the first data;
accessing third data corresponding to a plurality of historical non-outlier events that have occurred in the specified environment;
combining at least subsets of the first data, the second data, and the third data into a combined dataset;
training a machine learning model with the combined dataset; and
determining, based on the trained machine learning model, whether a new event in the specified environment is an outlier event.

12. The system of claim 11, wherein:
the specified environment comprises an electronic commerce environment, an information security environment, a healthcare environment, a natural phenomenon environment, a financial markets environment, or an electrical power grid environment; and
the historical outlier events comprise a fraudulent transaction in the electronic commerce environment, a cyber-attack in the information security environment, a disease in the healthcare environment, a natural disaster in the natural phenomenon environment, a volatility exceeding a first threshold in the financial markets environment, or an unexpected surge exceeding a second threshold in the electrical power grid environment.

13. The system of claim 11, further comprising:
retraining the machine learning model based on additional data corresponding to new outlier events that have occurred after an initial training of the machine learning model;
comparing a performance of the retrained machine learning model with a performance of the initially trained machine learning model; and
selecting, based on a result of the comparing, one of the retrained machine learning model or the initially trained machine learning model to perform the determining.

14. The system of claim 11, further comprising: assigning, based on a Shapley Additive Explanation (SHAP) model, an importance to each of the plurality of different types of parameters in the training of the machine learning model.

15. The system of claim 11, further comprising: adjusting the subsets of the first data, the second data, or the third data until a specified ratio is achieved between the second data and the first data.

16. The system of claim 11, wherein the determining is performed in response to the new event issuing a request to access a resource in the specified environment, and wherein the operations further comprise:
denying the request when the new event is determined to be the outlier event; or
granting the request when the new event is determined to not be the outlier event.

17. The system of claim 16, wherein the operations further comprise: when the request is denied, providing, to entity associated with the new event, a reason why the request is denied, wherein the reason is based at least in part on the trained machine learning model.

18. A non-transitory machine-readable medium having stored thereon machine-readable instructions executable to cause a machine to perform operations comprising:
accessing historical outlier data corresponding to a plurality of user accounts, wherein the historical outlier data comprises a plurality of parameters, and wherein an amount of the historical outlier data is insufficient to train a machine learning model;
generating, based on the historical outlier data and using a minority oversampling technique, synthetic outlier data associated with the plurality of user accounts;
generating an aggregated dataset based on at least a subset of the historical outlier data, at least a subset of the synthetic outlier data, and at least a subset of historical non-outlier data associated with the plurality of user accounts;
training a machine learning model with the aggregated dataset;
accessing new data after the machine learning model has been trained, the new data containing a request to access a resource; and
determining, based on the trained machine learning model, whether the new data should be classified as outlier data or non-outlier data.

19. The non-transitory machine-readable medium of claim 18, wherein the resource comprises a use account of the plurality of user accounts, and wherein the operations further comprise:
denying, based on a determination that the new data should be classified as outlier data, the request to access the resource; and
providing, to an entity associated with the new data, an explanation why the request is denied, wherein the explanation is generated at least in part based on the trained machine learning model.

20. The non-transitory machine-readable medium of claim 18, wherein the operations further comprise:
retraining the machine learning model based on additional outlier data received after an initial training of the machine learning model;
comparing a performance of the retrained machine learning model with a performance of the initially trained machine learning model; and
selecting, based on a result of the comparing, one of the retrained machine learning model or the initially trained machine learning model to perform the determining.
